(19) United States
(12) Patent Application Publication
(10) Pub. No.: US 2021/0280187 A1
(43) Pub. Date: Sep. 9, 2021

(54) INFORMATION PROCESSING APPARATUS AND INFORMATION PROCESSING METHOD

(71) Applicant: SONY CORPORATION, TOKYO (JP)

(72) Inventors: KENJI HISANAGA, TOKYO (JP); KENJI OGAWA, TOKYO (JP); TAICHI SHIMOYASHIKI, TOKYO (JP); YOICHI KOBORI, TOKYO (JP); NOBUYUKI TANAKA, TOKYO (JP); AKIHIKO IZUMI, TOKYO (JP); KAZUFUMI CHO, TOKYO (JP)

(21) Appl. No.: 17/256,535

(22) PCT Filed: Jun. 19, 2019
(86) PCT No.: PCT/JP2019/024296

§ 371 Date: Dec. 28, 2020

(30) Foreign Application Priority Data
Jul. 3, 2018 (JP) 2018-126773

(51) Int. Cl. G10L 15/22; G06F 3/16; G10L 17/22; G10L 15/18; G10L 15/02

(52) U.S. Cl. CPC G10L 15/22; G06F 3/167; G10L 2015/223; G10L 15/1822; G10L 15/02; G10L 17/22

(57) ABSTRACT

In a mashup agent 23 that is an information processing apparatus, a controller is configured to perform control to detect an intent of a user, operate an agent capable of providing a service corresponding to the detected intent of the user, and present, to the user, a result supplied to the agent from the service.

### TECHNICAL FIELD

The present technology relates to an information processing apparatus and an information processing method that selectively uses one or more individual agents adapted to an intent of a user among multiple individual agents capable of operating services on the cloud through interaction with a user.

### BACKGROUND ART

An AI assistant service in which information requesting a service from a user is received, the service is operated on the basis of this information, and a result of the service is presented to the user has been recently prevailing (see, for example, Patent Literature 1). Further, a cloud-based voice AI assistant service is also known in which request information is input from a user through voice and a result of the service is presented to the user through speech or display. Further, the field of utilization of such voice AI assistant services has been recently increasing, and there are also known smart speakers such as Amazon Echo (registered trademark) and Google Home (registered trademark) used in a home, and others used in a vehicle.

### CITATION LIST

### Patent Literature

Patent Literature 1: Japanese Patent Application Laid-open No. 2015-022310

### DISCLOSURE OF INVENTION

### Technical Problem

As described above, there have been various kinds of AI assistant service agents in recent years. So, it is anticipated that one user will differently use multiple agents depending on the purposes and the like in the future.

However, since an operation method for each agent, for example, a trigger for starting the agent, commands, and the like are different, if the user differently uses the services of each agent as appropriate, it is anticipated that the burden on the operation by the user increases. In addition, since each agent is independent of others, the services of multiple agents have been used individually.

It is an object of the present technology to provide an information processing apparatus and an information processing method that are capable of improving the operability of a user, such as enabling a user to selectively use services of multiple agents without being aware of the type of agent in an environment in which services of multiple types of agents can be provided.

### Solution to Problem

In order to solve the problems described above, an information processing apparatus according to an embodiment of the present technology includes a controller configured to perform control to detect an intent of a user, operate an agent capable of providing a service corresponding to the detected intent of the user, and present, to the user, a result provided to the agent from the service.

The controller may operate multiple agents capable of respectively providing multiple services corresponding to the detected intent of the user, and present, to the user, results respectively provided to the multiple agents from the multiple services.

The controller may present, to the user, the results respectively provided to the multiple agents from the multiple services together with an evaluation result of the results.

The information processing apparatus may further include a voice input unit that inputs the intent of the user through voice.

The controller may present the result of the service to the user through speech, screen display, or both of the speech and the screen display.

Further, the controller may save communication between the user and one of the agents as session data in a session data storage unit, and communicate with another one of the agents by using the session data saved in the session data storage unit.

In addition, the controller may present, when receiving a question absent in the session data from the other agent during communication with the other agent, the question to the user and transmit an answer of the user to the other agent.

The controller may disable, when the user inputs a command speech with trigger for activating the individual agent, a detection of the intent of the user from the command speech.

When a function of one of the specific services is being used and when an intent of the user to use a function of another specific service is detected, the function of the other specific service being prevented from being used simultaneously with the function of the one specific service, the controller may be configured to prevent use of the function of the other specific service based on the intent of the user.

When a relationship between a function of the service used for the detected intent of the user and a surrounding situation corresponds to a specific prevention condition, the controller may be configured to prevent use of the function of the service for the detected intent of the user.

An information processing method according to another embodiment of the present technology includes: by a controller, detecting an intent of a user; operating an agent capable of operating a service corresponding to the detected intent of the user; and presenting, to the user, a result provided to the agent from the service.

### Advantageous Effects of Invention

As described above, according to the present technology, it is possible to improve the operability of a user, such as enabling a user to use services of multiple agents without being aware of the type of agent in an environment in which services of multiple types of agents can be provided.

### BRIEF DESCRIPTION OF DRAWINGS

FIG. 1 is a block diagram showing a configuration of a system 1 including a mashup agent 23 that is an information processing apparatus of a first embodiment according to the present technology.

FIG. 2 is a block diagram showing a hardware configuration of the mashup agent 23 in the system 1 of FIG. 1.

FIG. 3 is a flowchart of a basic operation in the system 1 of FIG. 1.

FIG. 4 is a block diagram for describing part 1 of mashup processing using multiple services.

FIG. 5 is a block diagram for describing Part 2 of mashup processing using multiple services.

FIG. 6 is a block diagram of the system 1 for describing the mashup processing using session data.

FIG. 7 is a block diagram of the system 1 for describing a specific example of processing of preventing the simultaneous use of multiple specific service functions.

FIG. 8 is a block diagram for describing a method of setting up a new service.

FIG. 9 is a flowchart showing a procedure of setting up a new service of FIG. 8.

FIG. 10 is a block diagram showing a configuration of the system 1 capable of saving unknown triggers and unknown commands.

FIG. 11 is a flowchart of an operation of saving unknown triggers and unknown commands.

FIG. 12 is a diagram showing a presentation example of search results and evaluation results thereof regarding a specific commodity that are respectively obtained by commodity search functions of two shopping services A and B respectively provided via two individual agents.

FIG. 13 is a diagram showing an example of a shopping mediation action tree.

### MODE(S) FOR CARRYING OUT THE INVENTION

An embodiment according to the present technology will be described below.

### First Embodiment

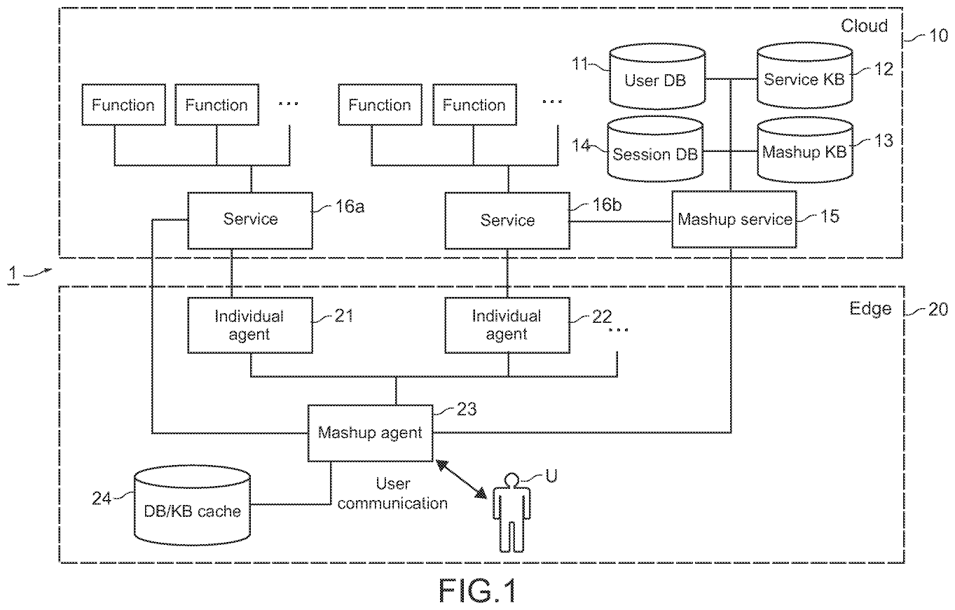

FIG. 1 is a block diagram showing a configuration of a system 1 including a mashup agent 23 that is an information processing apparatus of a first embodiment according to the present technology.

(Gist of Embodiment)

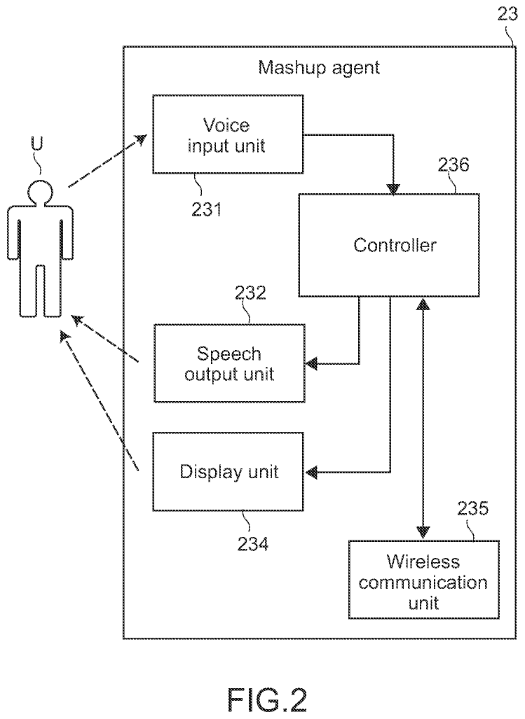

The mashup agent 23, which is an information processing apparatus of the first embodiment according to the present technology, includes a controller 236 (see FIG. 2) that detects an intent of a user U, operates an individual agent (21 or 22) capable of providing a service (16a or 16b) corresponding to the detected intent of the user U, and presents a result provided from the service (16a or 16b) to the user U by the individual agent (21 or 22).

The individual agents 21 and 22 are agents of AI assistant services that are different from each other and are capable of operating the services 16a and 16b independently of each other.

Here, “operating a service” means that each of the individual agents 21 and 22 selects a function to be executed by the service and causes the service to execute the function. “Operating an individual agent” means that the mashup agent 23 selects, in order to provide a service corresponding to the intent of the user U, an individual agent capable of providing that service and causes the individual agent to operate the service.

Hereinafter, the configuration and operation of the system 1 including the mashup agent 23 of the first embodiment will be described in more detail.

As shown in FIG. 1, the system 1 includes a cloud 10 and an edge 20.

The cloud 10 includes multiple services 16a and 16b operable by the individual agents 21 and 22, respectively. Each of the services 16a and 16b has one or more functions. In addition, the cloud 10 includes a mashup service 15 and various databases/knowledge bases 11, 12, 13, and 14.

The mashup service 15 and the services 16a and 16b are each configured by a computer. Each of those computers includes a program and data necessary to execute a particular function, and executes a particular function in response to a request from the individual agents 21 and 22, the mashup agent 23, and the like.

Meanwhile, the edge 20 includes an individual agent 21 that mediates two-way communication between the user U and the service 16a, an individual agent 22 that mediates two-way communication between the user U and the service 16b, and the mashup agent 23 that mediates two-way communication between the user U and each of the individual agents 21 and 22.

The mashup agent 23 acts as a front end to the user U. The mashup agent 23 detects the intent of the user from communication input from the user U, for example, through voice or the like. The intent of the user is a matter to be solved by the user U using a function of the service 16a or 16b, such as “wish to purchase X” or “wish to take reservation of Y”. The mashup agent 23 is configured to determine and operate an individual agent capable of providing a service corresponding to the detected intent of the user, receive a result provided by the service from the individual agent, and present the result to the user U. Such series of processing by the mashup agent 23 is referred to as “mashup processing” in this embodiment.

Further, similarly to the individual agents 21 and 22, the mashup agent 23 is capable of directly accessing various services on the cloud 10 to use the functions of those services.

In order to operate an individual agent with the type that performs communication with the user U through speech, the mashup agent 23 synthesizes and outputs a command speech with trigger, which includes a trigger for activating the individual agent and a command for service operation, interprets a speech response from the individual agent by speech recognition, and generates presentation information for the user U.

Further, the mashup agent 23 may communicate with the individual agent using e-mail, social networking service (SNS) messages, or the like.

(Configuration of Mashup Agent 23)

FIG. 2 is a block diagram showing a hardware configuration of the mashup agent 23.

The mashup agent 23 includes a voice input unit 231, a speech output unit 232, a display unit 234, a wireless communication unit 235, and a controller 236. The voice input unit 231 inputs the voice of the user U. The speech output unit 232 is for notifying the user U of a result of a service or the like through speech. Further, the speech output unit 232 outputs a command speech with trigger, which corresponds to the intent of the user, to an individual agent that performs the voice AI assistant service. The display unit 234 is for notifying the user U of a result of a service through display. The wireless communication unit 235 communicates with various services on the cloud 10, and further communicates with a user information terminal such as a smartphone or a mobile phone of the user U. The controller 236 performs recognition of a voice taken in from the voice input unit 231, artificial intelligence (AI) processing based on information such as an intent of the user obtained by speech recognition or the like, synthesizes a speech to be output to the speech output unit 232, and performs generation processing of screen data to be displayed on the display unit 234.

The controller 236 mainly includes a central processing unit (CPU), a main memory, a read only memory (ROM), and the like. The main memory or the ROM stores programs to be executed by the CPU.

In addition, the mashup agent 23 further includes a cache 24 for the data/knowledge of the various databases/knowledge bases 11, 12, 13, and 14 located in the cloud 10. The cache 24 may be built in the mashup agent 23 or may exist outside the mashup agent 23. The cache 24 includes large-capacity storage, for example, a hard disk drive (HDD), a solid state drive (SSD), another semiconductor memory device, an optical disk drive, and the like.

Since the hardware configuration of the individual agents 21 and 22 is basically similar to that of the mashup agent 23, description thereof will be omitted here.

Now, the description of FIG. 1 will be continued. The mashup service 15 on the cloud 10 is capable of directly accessing the service 16a or 16b corresponding to the intent of the user U with reference to the various databases/knowledge bases 11, 12, 13, and 14 located in the cloud 10 in response to a request from the mashup agent 23. The mashup service 15 responds to the mashup agent 23 with the result provided by the service 16a or 16b.

(Regarding Various Databases/Knowledge Bases and Cache)

In this system 1, a user database 11, a service knowledge base 12, a mashup knowledge base 13, and a session database 14 are located on the cloud 10, and a cache 24 of those databases 11 and 14 and knowledge bases 12 and 13 is provided in the edge 20.

The user database 11 (hereinafter, referred to as “user DB 11”) saves various kinds of information related to an individual user, such as a service identifier of a service that can be used by the user U, user account information necessary for the user U to use the service, and point information accumulated for each service when the service is used.

The service knowledge base 12 (hereinafter, referred to as “service KB 12”) stores a service identifier, a method of operating an individual agent that operates a service, a method of interpreting a response from an individual agent, and the like. The method of operating an individual agent includes a speech-based operation method input using a microphone or a mobile telephone from the edge 20, a Web API for operating a service from the mashup agent 23, and the like. The operation method using speech input from the edge 20 includes, for example, information such as a trigger (wake command) for activating the individual agent, a command for service operation, and the like.

The mashup knowledge base 13 (hereinafter, referred to as “mashup KB 13”) stores action trees or the like for each user action identifier as mashup knowledge. The user action identifier is an identifier of a matter the user wants to accomplish using services, such as purchasing a commodity, reserving/planning a travel, or reproducing music/video. The user action identifier is generated by the mashup agent 23 on the basis of the intent of the user extracted by the mashup agent 23 from communication with the user U. The action tree is a data structure in which a procedure of an action for achieving the intent of the user by operating one or more services on the cloud, or the like is represented by a tree structure.

The session database 14 (hereinafter, referred to as “session DB 14”) saves the content of communication between the user U and a service until one intent of the user is achieved by operating one or more services on the cloud, as session data.

(Basic Operation of Mashup)

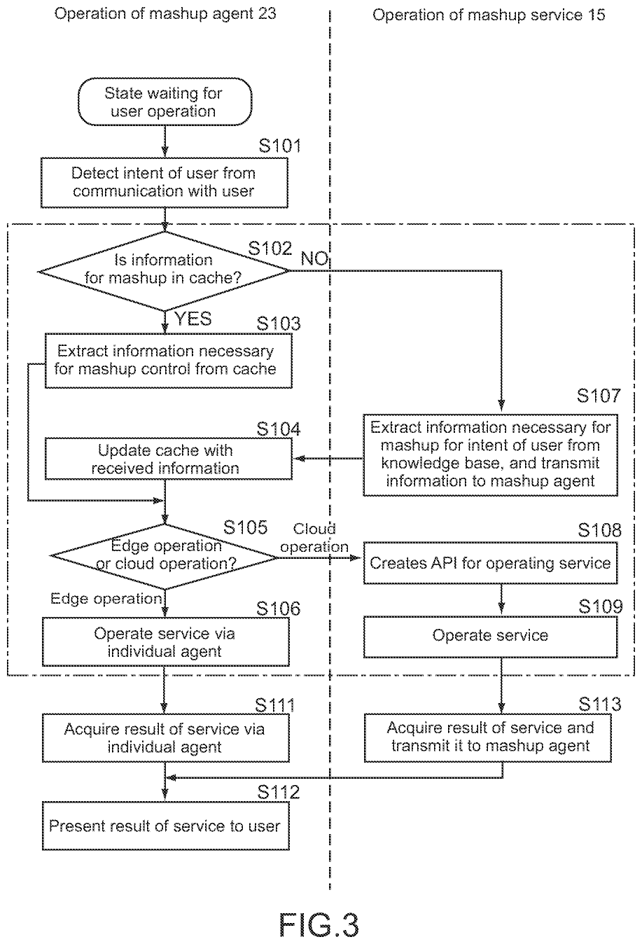

FIG. 3 is a flowchart of a basic operation in the system 1 of this embodiment.

First, the controller 236 of the mashup agent 23 detects the intent of the user from the content of the communication with the user U (Step S101). When detecting the intent of the user, the controller 236 of the mashup agent 23 generates a user action identifier corresponding to the intent of the user, and checks whether information necessary to perform mashup for the intent of the user (hereinafter, such information is referred to as “mashup knowledge”), such as an action tree corresponding to the user action identifier and information regarding a service described in the action tree, is held in the cache 24 or not (Step S102).

If a target mashup knowledge is held in the cache 24 (YES in Step S102), the controller 236 of the mashup agent 23 extracts an appropriate mashup knowledge from the cache 24 (Step S103).

Next, the controller 236 of the mashup agent 23 confirms a method of operating the service described in the action tree included in the extracted mashup knowledge, from the information regarding the service included in the mashup knowledge. Here, the method of operating the service can be roughly divided into “edge operation (speech input)” and “cloud operation (Web API)” (Step S105). If the method of operating the service is “edge operation (speech input)”, the controller 236 of the mashup agent 23 synthesizes a command speech with trigger for operating the service via the individual agent according to the method of operating the service, and outputs the synthesized command speech from the speech output unit 232 (Step S106). For example, if the service described in the action tree is the service 16a, the controller 236 outputs a command speech with trigger for operating the service 16a via the individual agent 21 capable of operating the service 16a.

Subsequently, the mashup agent 23 acquires a result provided from the service 16a via the individual agent 21 (Step S111), and presents the result to the user U through speech, screen display, or both of them (Step S112).

Further, if the method of operating the service is “cloud operation (Web API)” in Step S105, the controller 236 of the mashup agent 23 transmits a mashup request including the service identifier of the service to the mashup service 15. Upon receiving the request, the mashup service 15 creates a Web API for operating the service corresponding to the service identifier included therein (Step S108), and uses this Web API to operate the service (Step S109). Upon acquiring a result of the service, the mashup service 15 transmits the result of the service to the mashup agent 23 (Step S113). The mashup agent 23 presents the result of the service acquired from the mashup service 15 to the user U through speech, screen display, or both of them (Step S112).

If it is determined in Step S102 that an appropriate mashup knowledge is not held in the cache 24 (NO in Step S102), the mashup agent 23 requests an appropriate mashup knowledge to the mashup service 15. Upon receiving the request, the mashup service 15 extracts an action tree corresponding to the user action identifier included in the request from the mashup KB 13, extracts information regarding the service described in the action tree from the service KB 12, and transmits those pieces of information to the mashup agent 23 (Step S107). The controller 236 of the mashup agent 23 saves the mashup knowledge, which is the information transmitted from the mashup agent 15, in the cache 24 and updates the cache 24 (Step S104). Subsequently, the operations subsequent to Step S105 described above are performed.

As described above, in the system 1 of this embodiment, the mashup agent 23 operates the individual agent capable of providing the service corresponding to the intent of the user and provides the service corresponding to the intent of the user to the user U. Thus, the user U can use the services of the multiple individual agents without selecting and activating the individual agents by user U. This improves the operability of the user U.

(Part 1 of Mashup Processing Using Multiple Services)

The description on the basic operation of the mashup is based on the assumption that a single service is to be used, but mashup processing using multiple services will be described next.

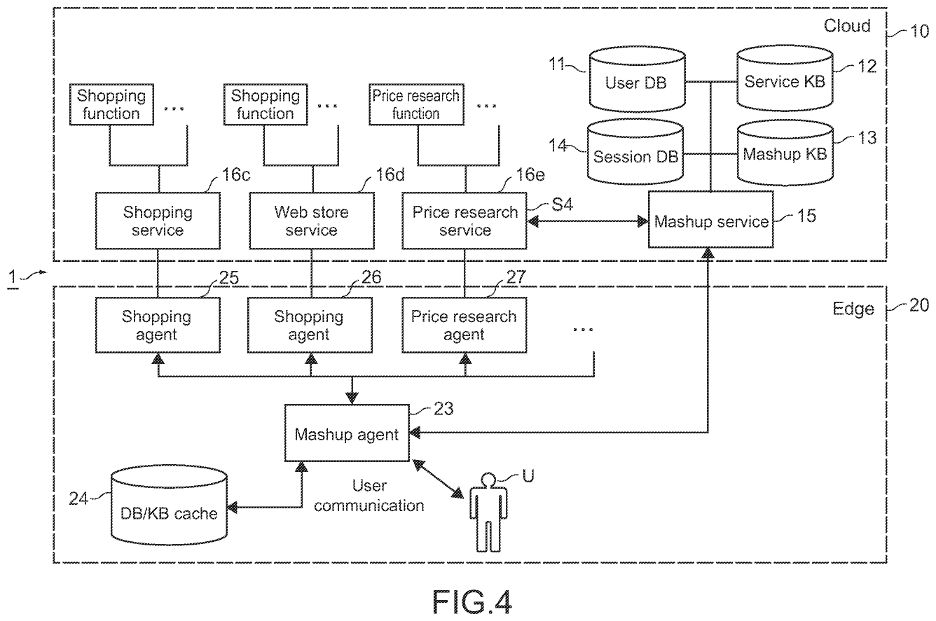

FIG. 4 is a block diagram for describing part 1 of mashup processing using multiple services.

In this example, it is assumed that the controller 236 of the mashup agent 23 detects, for example, an intent of a user of “wish to purchase a commodity X” from the content of communication with the user U.

The controller 236 of the mashup agent 23 generates a user action identifier corresponding to the detected intent of the user. Here, description will be given assuming that mashup knowledge for the user action identifier is held in the cache 24 in the edge 20. It is assumed that the action tree corresponding to the user action identifier is, for example, “to research the price of a target commodity of each of multiple shopping services by using a price research service, recommend the user to purchase the commodity from a shopping service with the lowest price, and purchase the target commodity from the shopping service selected by the user”.

The controller 236 of the mashup agent 23 checks a method of operating a price research service 16e on the basis of the mashup knowledge extracted from the cache 24. If the method of operating the price research service 16e is “speech input”, the controller 236 of the mashup agent 23 synthesizes a command speech with trigger, which includes a trigger for activating a price research agent 27, information for specifying the target commodity X, a command for requesting a price research, and the like, and outputs the synthesized command speech from the speech output unit 232. The price research agent 27 operates the price research service 16e on the basis of the command speech with trigger, and acquires a result of the service by the price research service 16e.

The controller 236 of the mashup agent 23 generates a response to be presented to the user U on the basis of the action tree from the result of the price research by the price research service 16e, and presents the response to the user U. For example, a response, e.g., “You are better off buying it from a shopping service 16c.” is generated and presented to the user U through speech, screen display, or both of them.

In response to the presented response, for example, it is assumed that the user U performs a voice input such as “Purchase the commodity X from the shopping service 16c.” The controller 236 of the mashup agent 23 determines the “shopping service 16c”, which is included in the voice of the user U, to be the selected shopping service on the basis of the action tree, and synthesizes and outputs a command speech with trigger for operating a shopping agent 25 to purchase the target commodity from the shopping service 16c.

The shopping agent 25 operates the shopping service 16c in accordance with the command speech with trigger to perform processing for purchasing the commodity X.

As described above, in the system 1 of this embodiment, the mashup agent 23 specifies multiple individual agents capable of respectively providing multiple services corresponding to the intent of the user, and activates the individual agents to respectively provide the multiple services corresponding to the intent of the user, so that the user U can use the services of the multiple individual agents without sequentially selecting and activating the multiple individual agents by the user. This improves the operability of the user U.

(Part 2 of Mashup Processing Using Multiple Services)

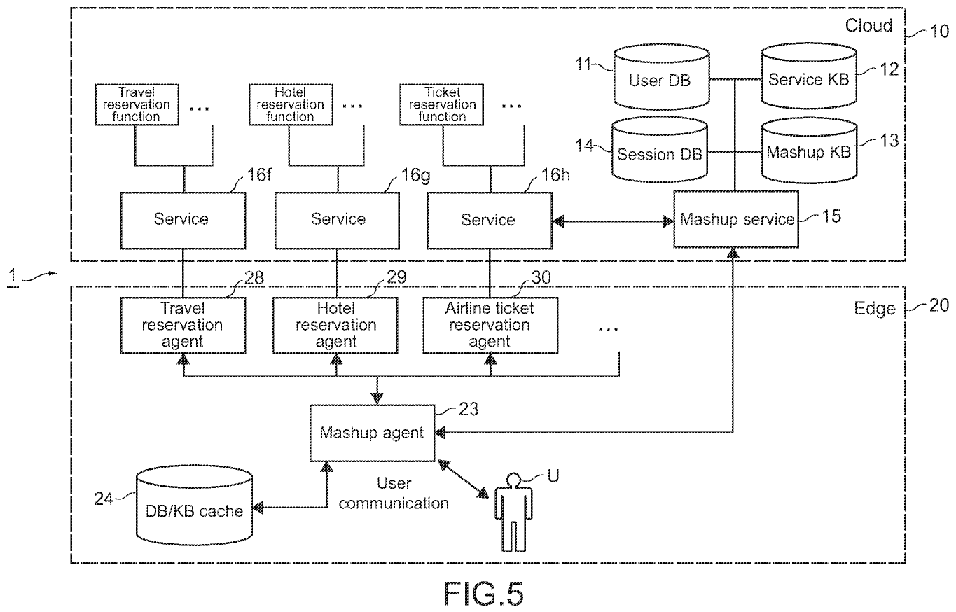

FIG. 5 is a block diagram for describing part 2 of mashup processing using multiple services.

This example is mashup processing when a rough intent of the user such as “wish to travel to X” or “wish to eat” is given from the user U, for example.

When detecting a rough intent of the user, for example, “wish to travel to X”, the controller 236 of the mashup agent 23 generates a user action identifier corresponding to the intent of the user and extracts the mashup knowledge including an action tree corresponding to the user action identifier from the cache 24. On the basis of the mashup knowledge, the controller 236 of the mashup agent 23 then performs mashup processing by operating multiple services as follows, for example. Note that the user DB 11 is assumed to also store information including age, gender, travel history, occupation, and the like of the user U, as information regarding the user U.

When determining that the destination of the travel meant by “X” of the rough user intent of “wish to travel to X” is overseas, the controller 236 of mashup agent 23 accesses a governmental site (web service) of the country of the travel destination to check the travel restrictions, checks whether the user U is the target of the travel restrictions or not on the basis of the information of the user U stored in the user DB 11, and presents the result to the user U through speech, screen display, or both of them.

If the user U is a person who is not subject to the travel restrictions, the controller 236 of the mashup agent 23 checks the user's passport and visa issuance status, and presents the results to the user U through speech, screen display, or both of them. Note that the user's passport and visa issuance status are managed in the user DB 11, so that the controller 236 of the mashup agent 23 can know them.

Next, the controller 236 of the mashup agent 23 operates a service 16f having a travel reservation function via a travel reservation agent 28, to collect travel plan information associated with the travel destination intended by the user U, and presents the travel plan information to the user U through speech, screen display, or both of them.

Further, in consideration of a case where the user U wants to take various reservations associated with the travel by the user U, the controller 236 of the mashup agent 23 operates multiple individual agents 29 and 30 capable of respectively providing services 16g and 16h having functions of ticket reservation of transportation, hotel reservation, rental car reservation, restaurant reservation, introduction of recommended spots, and the like, and presents multiple information screens corresponding to results provided from the respective services to the user U.

When the user U finds a service that the user U wants to actually use on the basis of the multiple information screens presented, the user U selects the service (for example, the service 16g) and transmits a new intent of the user, such as reservation or purchase, to the mashup agent 23 through voice or the like. Thus, the controller 236 of the mashup agent 23 synthesizes and outputs a command speech with trigger directed to a hotel reservation agent 29 capable of operating the selected service 16g. Thus, the function of the selected service 16g is executed, and the result is presented to the user U via the hotel reservation agent 29 and the mashup agent 23.

As described above, in the system 1 of this embodiment, if a rough intent of the user such as “wish to travel to X” is simply given to the mashup agent 23 from the user U, multiple individual agents capable of providing multiple services corresponding to the rough intent of the user are activated to provide the multiple services. This improves the operability of the user U.

(Mashup Processing Using Session Data)

In the system 1 of this embodiment, the controller 236 of the mashup agent 23 may be configured to save, as session data, communication between the user and one of the individual agents in the cache 24 and to communicate with the other individual agent using the session data saved in the cache 24.

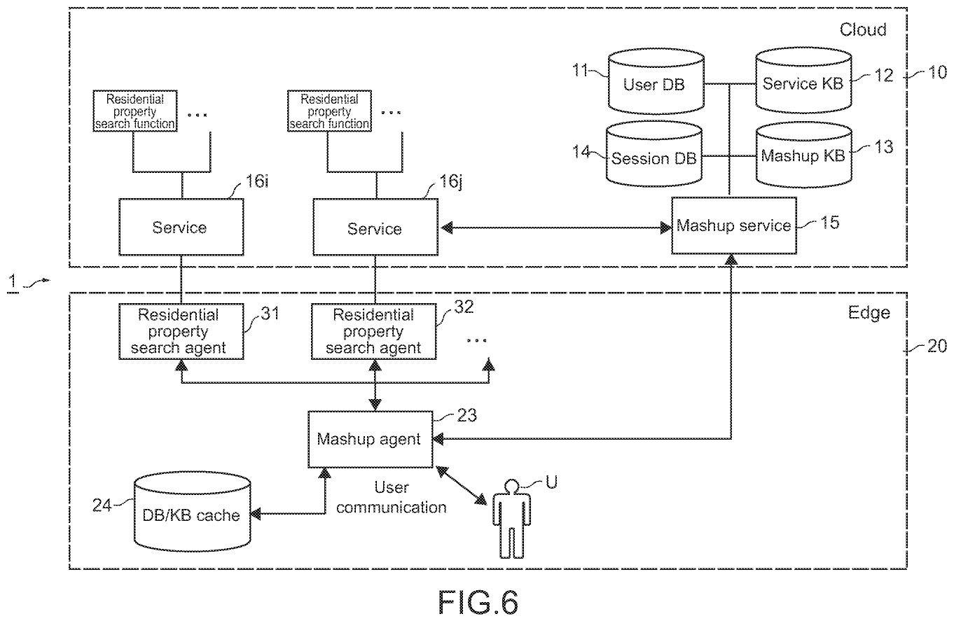

FIG. 6 is a block diagram of the system 1 for describing the mashup processing using the session data.

In this example, the controller 236 of the mashup agent 23 sequentially performs substantially equivalent communication with multiple individual agents 31 and 32 to operate multiple services 16i and 16j, respectively, and presents a result obtained by, for example, integrating the results provided by the multiple services 16i and 16j and received by the multiple individual agents 31 and 32, to the user U.

The session data is used to sequentially perform substantially equivalent communication with the multiple individual agents 31 and 32.

In the session DB 14 and the cache 24, the content of mutual communication between the user U and one individual agent, which is mediated by the mashup agent 23, is saved as session data.

Here, it is assumed that an individual agent that is the communication partner with the user U when the session data is collected is a residential property search agent 31 shown in FIG. 6. In the system 1 of FIG. 6, there is another residential property search agent 32 having a similar residential property search function. In this case, the controller 236 of the mashup agent 23 communications with the other residential property search agent 32 using the session data described above on behalf of the user U.

For example, it is assumed that the following communication has been performed between the user U and the one residential property search agent 31 through the mediation of the mashup agent 23.

1. The residential property search agent 31 asks the user U, “Do you have any desires for house rent?”

2. In response to this question, the user U answers, “100,000 yen or less.”

3. The residential property search agent 31 asks the user U, “Do you have any desires for the direction of the room?”

4. The user U answers, “Southward.”

5. The residential property search agent 31 asks the user U, “Do you have any desire for a room layout?”

6. The user U answers, “1LDK (one room, living room, and dining room with kitchen).”

The controller 236 of the mashup agent 23 saves the content of the communication 1 to 6 described above as session data in the session DB 14.

Subsequently, the controller 236 of the mashup agent 23 activates the other property search function agent 32 and generates answers to the questions from the property search function agent 32 to the user U on the basis of the session data saved in the session DB 14.

For example, the following communication is performed between the mashup agent 23 and the residential property search agent 32.

1. The residential property search agent 32 asks the user, “What is the rent budget?”

2. In response to this question, the controller 236 of the mashup agent 23 answers, “100,000 yen or less”, on the basis of the session data.

3. The residential property search agent 32 asks the user U, “Do you have any desires for the direction of the room?”

4. In response to this question, the controller 236 of the mashup agent 23 answers, “Southward”, on the basis of the session data.

5. The residential property search agent 32 asks, “What is the condition of transportation?” The content of this question does not exist in the session data of the session DB 14, and thus the controller 236 of the mashup agent 23 presents this question to the user U.

6. The user U answers, “Within 5-minute walk.” The mashup agent 23 transmits this answer to the residential property search agent 32.

The controller 236 of the mashup agent 23 then presents the results provided from the multiple services 16i and 16j via the multiple residential property search agents 31 and 32 to the user U through speech, screen display, or both of them.

In such a manner, when multiple services having a similar function are used under similar conditions, the content of the communication between one individual service agent used first and the user is saved in the session DB 14 as session data. Between the other individual service agent used next and the user, the mashup agent 23 generates answers for questions from the other individual service agent on the basis of the session data saved in the session DB 14, and responds to the individual agent. This allows the user U to obtain the results of the multiple services without repeating similar answers to the multiple individual agents. This increases the operability of the user.

(Processing in Inputting Command Speech with Trigger)

Hereinabove, description has been given on the case where the mashup agent 23 detects the intent of the user from communication with the user U and operates a service that solves the intent of the user via an individual agent in accordance with an action tree corresponding to the intent of the user.

For example, when the user U inputs the voice, “wish to listen to music using an individual agent G”, the controller 236 of the mashup agent 23 causes the individual agent G to react by synthesizing and outputting a command speech with trigger including an activation trigger for the individual agent G and a music playback command.

In response to this, when the mashup agent 23 inputs a command speech with trigger of an individual agent of a typical voice AI assistant system, such as “OK Google (registered trademark), do XX”, from the user U, the mashup agent 23 causes the individual agent to respond to the command speech by disabling the detection of the intent of the user from the command speech. This can avoid the execution of extra processing by the mashup agent 23.

(Prevention of Simultaneous Use of Multiple Specific Service Functions)

There are combinations of functions of multiple services unsuitable for simultaneous use in a single edge 20. For example, a situation in which music playback functions of multiple services are simultaneously activated and music is played by each function is generally undesirable. Further, even if multiple music playback functions are permitted to be activated together, it is desirable that the playback of the speech is permitted for only one of the music playback functions.

When the music playback function of one service is being used and when the intent of the user to use the music playback function of another service is detected, for example, the controller 236 of the mashup agent 23 ignores the intent of the user and does not activate the individual agent that operates the other service in order to prevent the functions of the multiple services unsuitable for simultaneous activation or use from being simultaneously used.

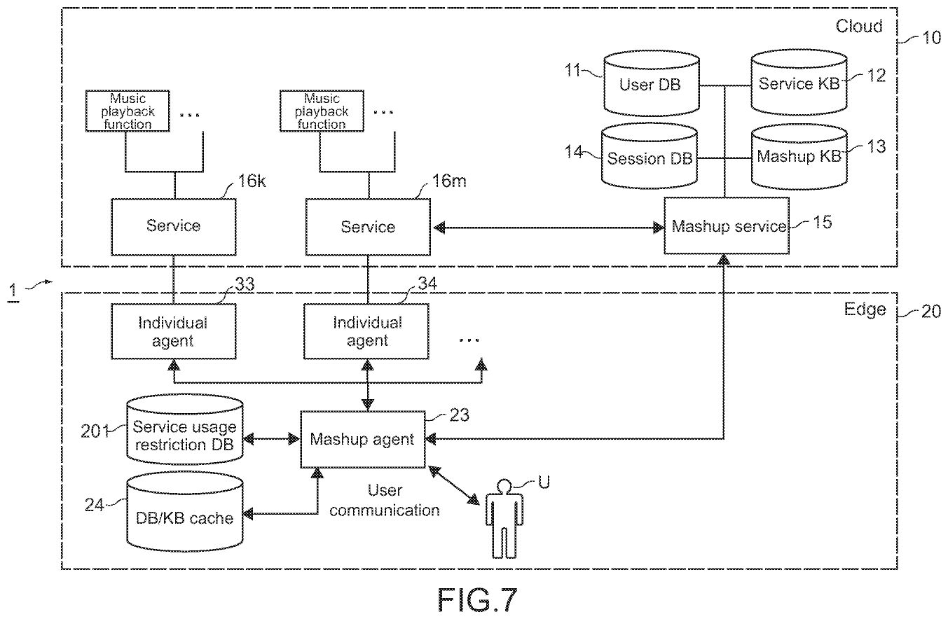

FIG. 7 is a block diagram of the system 1 for describing a specific example of processing of preventing the simultaneous use of multiple specific service functions.

The edge 20 includes a service usage restriction database 201 that stores information of combinations of functions of multiple services unsuitable for simultaneous use.

For example, it is assumed that both a service 16k and a service 16m have a music playback function. One service 16k is operable by one individual agent 33, and another service 16m is operable by another individual agent 34. The service usage restriction database 201 is assumed to store information indicating that the music playback function of the service 16k and the music playback function of the service 16m have a combination of the functions of the multiple services unsuitable for simultaneous use.

Under such a condition, for example, when the music playback function of the service 16k is used by the user U, the controller 236 of the mashup agent 23 does not activate the individual agent 34 that operates the other service 16m by, for example, ignoring the intent of the user, even if the intent of the user to use the music playback function of the other service 16m is detected. Thus, the music playback functions of the multiple services 16k and 16m are prevented from being simultaneously used.

(Usage Prevention of Specific Service Functions Depending on Surrounding Conditions)

In addition, the service usage restriction database 201 stores, in addition to the information regarding the combinations of the functions of the multiple services unsuitable for simultaneous use, a relationship between a peripheral status, such as whether a player device for music playback is powered on or not, and a function of a service unavailable for the peripheral status, as a prevention condition. For example, when the player device is not powered on, all service functions for playing music are prevented from being used.

Upon detecting the intent of the user, the controller 236 of the mashup agent 23 checks the peripheral status and determines whether or not the relationship between the function of the service to be used for the detected intent of the user and the peripheral status is a relationship stored in the service usage restriction database 201 as a prevention condition. When determining that the relationship between the function of the service to be used for the detected intent of the user and the peripheral status satisfies the prevention condition, the controller 236 of the mashup agent 23 disables the function of the service for the detected intent of the user and prevents the function from being used. This makes it possible to prevent unnecessary use of a service function, such as using a music playback function of a service even though the player device is not powered on, for example.

(New Service Setup Method)

Next, a setup method for introducing a new service into the edge 20 will be described.

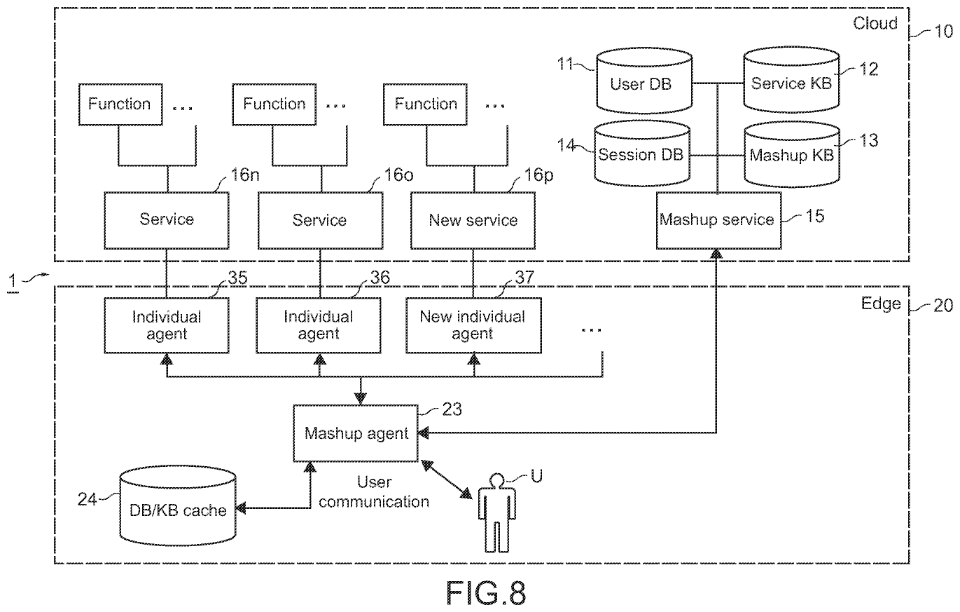

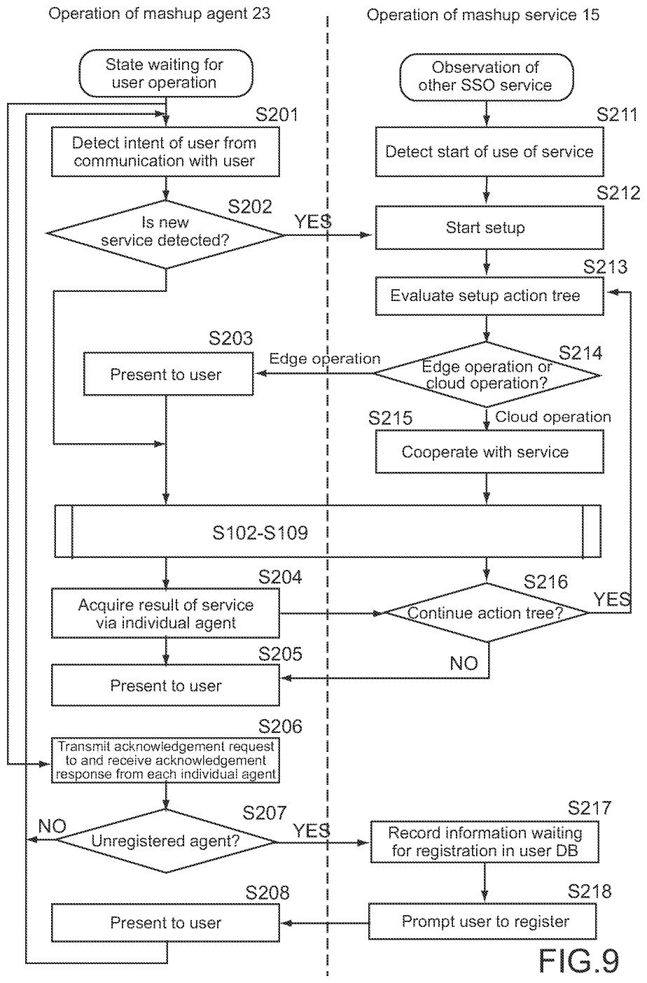

FIG. 8 is a block diagram for describing the method of setting up a new service. FIG. 9 is a flowchart showing a procedure for setting up a new service. Note that introducing a new service involves introducing a new individual agent.

The service KB 12 stores setup method action trees in association with service identifiers as information on the method of setting up various services. In addition, SSO (Single Sign-On) supported for each service, a trigger method of the individual agent (command for activation), the response content of the service to the command for activation, and the like are registered in the service KB 12. Further, the identifier of SSO used for each user is managed in the user DB 11.

The controller 236 of the mashup agent 23 detects the intent of the user from communication with the user (Step S201). If the intent of the user is a request for the user U to use a new service 16p (YES in Step S202), the controller 236 of the mashup agent 23 notifies the mashup service 15 of the content of the request.

Meanwhile, after detecting that the use of a non-installed service (including the service 16p) supporting the SSO to be used by the user U is started (Step S211), the mashup service 15 receives the use request by the user U from the mashup agent 23, and reads from the service KB 12 a setup method action tree in which the setup method for the service 16p is described in a tree structure. On the basis of the setup method action tree, the mashup service 15 starts the setup to enable an individual agent 37 of the service 16p to be used as the communication partner by the mashup agent 23 (Step S212).

While the mashup service 15 evaluates the setup method action tree, i.e., searches for and executes an uncompleted action in the setup method action tree (Step S213), the mashup service 15 presents the operation method of the action requiring the operation (edge operation) of the user U to the user U via the mashup agent 23 through speech, screen display, or both of them (from Step S214 to S203). The user U communicates with the individual agent 37 to try to operate the service 16p via the mashup agent 23 in accordance with the presented operation method.

When acquiring a result provided by the service 16p via the individual agent 37 (Step S204), the mashup agent 23 notifies the mashup service 15 of the acquisition of the result. Upon receiving this notification, the mashup service 15 searches for the result of the service 16p and the setup method action tree to determine the next action (from Step S216 to S213) and performs the action if the next action exists.

Further, the mashup service 15 executes the action necessary for communication with the service p (from Step S214 to S215). For example, the mashup service 15 receives permission from the service 16p such that the mashup agent 23 can use the individual agent 37 operating the new service 16p as the communication partner. Upon obtaining the permission from the service 16p, the mashup service 15 registers setup information including a service identifier and the like of the service 16p in the mashup KB 13. The setup information regarding the service 16p registered in the mashup KB 13 is also held in the cache 24 of the edge 20 (Step SS102 to S109).

This allows the individual agent 37 operating the new service 16p to be used as a communication partner of the mashup agent 23, which is presented to the user U through speech, screen display, or both of them (Step S205).

In addition, the controller 236 of the mashup agent 23 periodically transmits acknowledgement requests to and receives acknowledgement responses from the individual agents 35, 36, and 37 of all the services 16n, 16o, and 16p introduced into the edge 20 (Step S206). Here, if a service (service 16p) that is registered in the service KB 12 and the mashup KB 13 but is not registered in the user DB 11 is detected (YES in Step S207), the controller 236 of the mashup agent 23 records information indicating that there is an unregistered service in the user DB 11 via the mashup service 15 (Step S217), and prompts the user U to register the service identifier of the service 16p (from Step S218 to S208). Subsequently, the service identifier of the service 16p is registered in the user DB 11 by the user U.

In such a manner, when the individual agent of the new service is set up such that the mashup agent 23 can use it, an operation method to be performed by the user U or the like is presented to the user U, so that the burden of the user U can be reduced.

(Accumulation of Unknown Triggers and Unknown Commands for Updating Mashup Knowledge)

For example, in a voice AI assistant system such as Google Home (registered trademark), in response to a voice input of a command with trigger from a user such as “OK Google (registered trademark), do XX”, an individual agent recognizes “OK Google (registered trademark)” as a trigger for activating the individual agent, and recognizes “do XX” as an operation command of a service.

In the system 1 of this embodiment, the service KB 12 saves the information of the triggers for activating the known individual agents and the information of the commands that can be requested for the services. In this regard, the mashup knowledge such as action trees selected by the mashup agent 23 for the intent of the user should be appropriately created depending on what services exist as services available to the user and what functions the existing services have. Therefore, when an unknown trigger is input from the user U or an unknown command is input, it is desirable to save the unknown trigger or command to be served for updating the mashup knowledge.

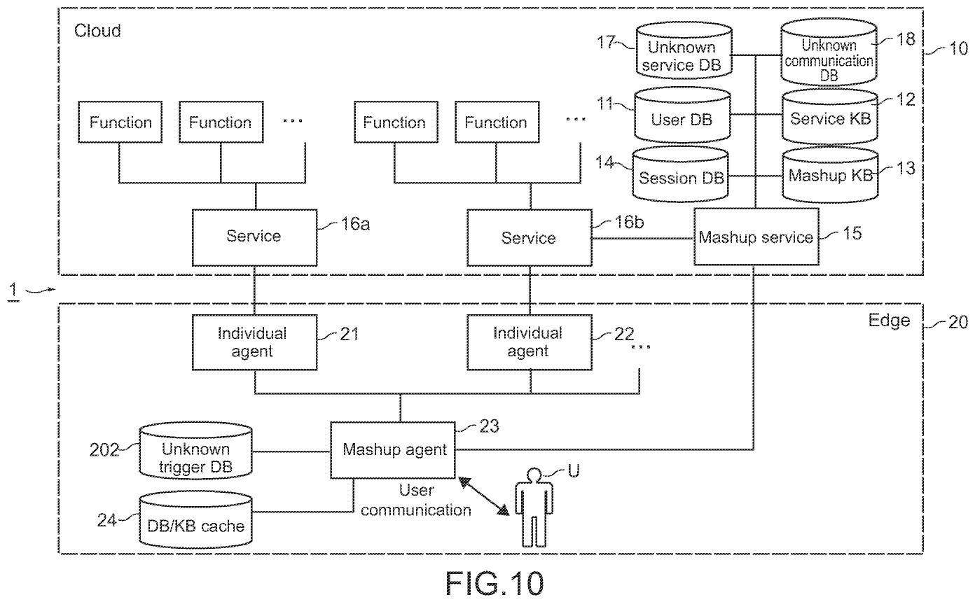

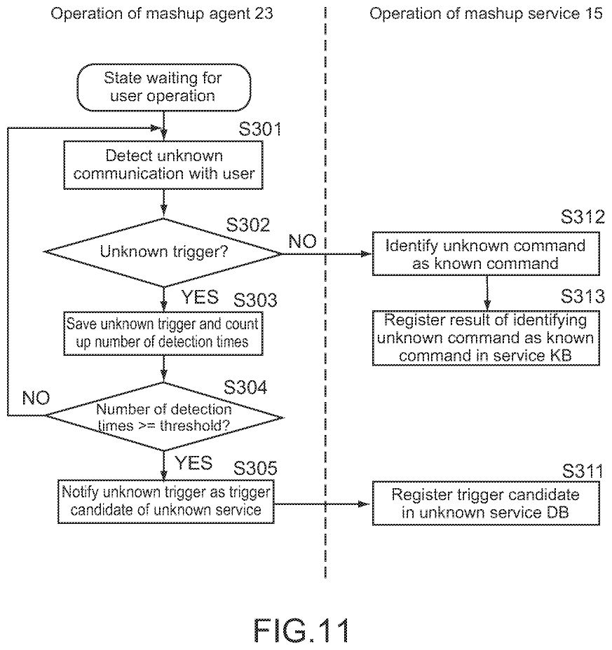

FIG. 10 is a block diagram showing a configuration of a system 1 capable of saving unknown triggers and unknown commands. FIG. 11 is a flowchart of an operation of saving unknown triggers and unknown commands.

When detecting an unknown communication (communication in which the trigger part or the command part is unknown) from the user U (Step S301), the controller 236 of the mashup agent 23 determines whether the trigger part of the unknown communication is for activating an individual agent of an unknown service, that is, an unknown trigger or not (Step S302).

When determining an unknown trigger (YES in Step S302), the controller 236 of the mashup agent 23 saves the unknown trigger in an unknown trigger DB 202 and saves the number of detection times for each type of the unknown trigger in the unknown trigger DB 202 (Step S303).

Next, when detecting an unknown trigger whose number of detection times reaches a threshold (YES in Step S304), the controller 236 of the mashup agent 23 requests the mashup service 15 to register the unknown trigger as a trigger candidate of the unknown service in an unknown service DB 17 on the cloud 10 (Step S305). In response to this request, the mashup service 15 registers the trigger candidate in the unknown service DB 17 (Step S311).

For example, suppose that a command with trigger of “Hi Nigel, do XX.” is input from the user U. Here, the trigger part “Hi Nigel” is determined to be an unknown trigger and saved in the unknown trigger DB 202. When the number of detection times of the unknown trigger of “Hi Nigel” reaches a threshold, the unknown trigger of “Hi Nigel” is registered as a trigger candidate of the unknown service in the unknown service DB 17 on the cloud 10.

Further, if the trigger of an unknown communication input from the user U is known but the command part thereof is unknown (NO in Step S Step S302), the controller 236 of the mashup agent 23 transmits to the mashup service 15 an unknown command examination request including the service identifiers of the known individual agent services activated by the known trigger in the input command with trigger, and the unknown command part (unknown command).

Upon receiving the unknown command examination request, the mashup service 15 reads base information for identifying a command for each of the services stored in an unknown communication DB 18 on the cloud 10 on the basis of the service identifiers included in the unknown command examination request. The base information for identifying a command for each of the services includes multiple words having substantially the same meaning as the known command for each service. That is, the mashup service 15 identifies the unknown command as the known command by evaluating which known command is substantially the same as the unknown command included in the unknown command examination request in the meaning of the word (Step S312). The mashup service 15 then registers a result of identifying the unknown command as the known command, in the service KB 12 (Step S313). That is, the relationship between the unknown command and the function of the service corresponding thereto is registered in the service KB 12.

For example, if a command with trigger of “OK Google (registered trademark), play a musical piece Z.” is input and the command “play” is an unknown command, it is estimated that the unknown command “play” has substantially the same meaning as the known command for activating the music playback function. Thus, the relationship between the command “play” and the music playback function is registered in the service KB 12.

For example, people who manage the mashup knowledge (hereinafter, referred to as “mashup knowledge managers”) checks whether the trigger candidate of the unknown service registered in the unknown service DB 17 is a trigger for activating an individual agent to provide some service, by referring to service disclosure information or the like. The service disclosure information is information disclosed with respect to all services that can be provided, including trigger information and the like. If the mashup knowledge managers confirm that the trigger candidate is a trigger for activating an individual agent capable of providing some service, the mashup knowledge managers register knowledge about the new service, such as the service identifier of the service and the trigger information, in the service KB 12.

The mashup knowledge managers use knowledge about the new service registered in the service KB 12 to update the mashup knowledge, for example, to create a new action tree or update an existing action tree. In addition, the new mashup knowledge registered in the mashup KB 13 is also registered in the cache 24.

Thus, the mashup service 15 and the controller 236 of the mashup agent 23 can thereafter select a new service that has been unknown until then or a new function of an existing service.

(Presentation of Service Result to User)

Next, a method of presenting a service result to the user U will be described. The presentation of a service result to the user U can be performed by a method using speech, a method using display, or both of them. The presentation method using display can present richer information than the presentation method using speech. An example of the presentation method using display will now be described.

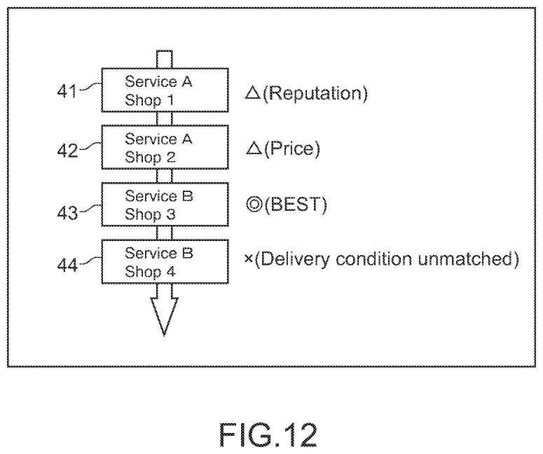

FIG. 12 is a diagram showing a presentation example of search results and evaluation results thereof regarding a specific commodity that are respectively obtained by commodity search functions of two shopping services A and B respectively operated via two individual agents.

In the figure, a shop 1 retrieved by a first shopping service A is denoted by reference numeral 41. A shop 2 retrieved and obtained by the first shopping service A is denoted by reference numeral 42. A shop 3 retrieved by a second shopping service B is denoted by reference numeral 43. A shop 4 retrieved by the second shopping service B is denoted by reference numeral 44. These search results are retrieved for shops that sell a specific commodity and include information such as prices of the commodity, reputation of the shops, and delivery conditions, in addition to identification information of the shops.

Here, the following case is assumed, in which the controller 236 of the mashup agent 23 evaluates each search result according to a shopping mediation action tree, e.g., “Recommend the user to purchase a commodity of an optimal shop from the result of comprehensively evaluating each shop on the basis of evaluation conditions such as price, reputation, and delivery conditions.”

For example, suppose that the following evaluation results are obtained for the respective shops 1 to 4.

Shop 1 has reputation that is not very good. Shop 2 provides a high price.

Shop 3 has a high evaluation on average.

Shop 4 does not meet the delivery date and time requirements.

The controller 236 of the mashup agent 23 determines, from the evaluation results of the respective shops 1 to 4, a shop having a comprehensively highest profit for the user. In this example, since the shop 3 is in the pass range in any of the evaluation items such as reputation, price, and delivery conditions, the user is recommended to purchase the commodity from the shop 3.

The user can refer to the presented search results and the evaluation results thereof and can input an intention to agree to the recommendation or an intention to purchase the commodity from a shop other than the recommendation, through voice or a touch operation on the search result displayed on a display apparatus.

The result of the user's selection of the shop is registered in the user DB 11 as information indicating points to be emphasized when the user selects the shop. This is reflected in the next shop evaluation by the controller 236 of the mashup agent 23.

(Shopping Mediation Action Tree)

Next, an example of shopping mediation based on a shopping mediation action tree will be described.

The action tree is a data structure in which multiple actions are described in a tree structure. The action tree can describe actions that control the order of actions. Further, the action tree can introduce a control structure such as repetition or conditional branching.

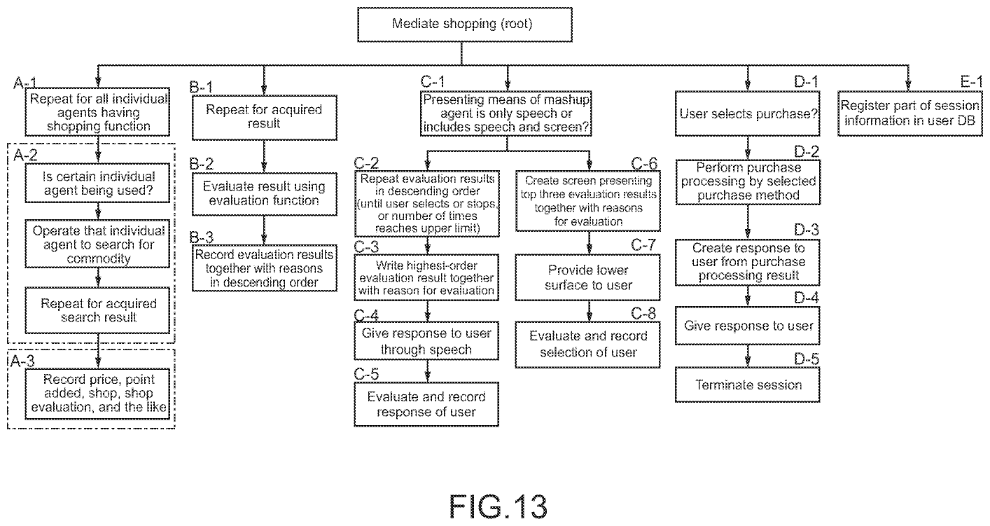

FIG. 13 is a diagram showing an example of the shopping mediation action tree.

In the shopping mediation action tree, evaluation is started from the root action and is shifted to the low-level actions of the root action. Details of the shopping mediation action tree will be described below.

A-1. Repeat the following A-2 and A-3 for all individual agents having a shopping function.

A-2. Operate one individual agent having a shopping function to search for a commodity desired by the user.

A-3. Record a price, a point addition result, a shop evaluation, and the like of the search result.

B-1. Repeat the following B-2 and B-3 for the result obtained in A-3 described above.

B-2. Evaluate the result obtained in A-3 described above using an evaluation function.

B-3. Record an evaluation result.

C-1. Branch the processing depending on whether the user presenting means of the controller 236 of the mashup agent 23 is only a loudspeaker or includes a loudspeaker and a screen.

C-2. Repeat, if the user presenting means is only a loudspeaker, the following C-3, C-4, and C-5 until the processing is completed for all evaluation results, until the user selects a shop, or until the user instructs completion.

C-3. Write the highest-order evaluation result together with the reason for evaluation.

C-4. Present the written evaluation result and reason for evaluation to the user through speech.

For example, the following speech is presented to the user U through the loudspeaker of the controller 236 of the mashup agent 23: “The recommended shop is Shop B1. The price is the second lowest. The evaluation of the shop is A. Purchase in this shop?”

C-5. Evaluate and record a response from the user.

C-6. Create, if the user presenting means includes a loudspeaker and a screen, screen data including the top N evaluation results together with the reasons for evaluation.

C-7. Present the screen data on the screen.

C-8. Evaluate and record a response from the user.

D-1. Upon detecting that the purchase of the commodity is selected by the user, perform the following D-1 to D-4.

D-2. Perform purchase processing by a purchase method selected by the user.

D-3. Create a response to the user from the result of the purchase processing.

D-4. Give the response to the user through speech or a screen.

D-5. Terminate the session.

E-1. Register part of the session information in the user DB.

(User Front End)

In the system 1 of this embodiment, the controller 236 of the mashup agent 23 supports communication with the user in various data formats.

Devices that receive the input of communication data from the user include, for example, a stationary or portable voice input device, a smartphone, and a mobile phone. Each of those devices allows the user to input communication data through voice. The smartphone and the mobile phone can input text-format communication data using e-mail transmission as well as voice.

The controller 236 of the mashup agent 23 recognizes the voice of the user input from any of the devices described above, generates speech in a format (activation words and commands) that can be interpreted by the individual agents in the edge 20, and supplies the speech to the individual agents.

In addition, the controller 236 of the mashup agent 23 can transmit text-format data obtained by recognizing the user's input voice to the mashup service 15 on the cloud 10 over a network.

Further, for example, when the text-format communication data using e-mail transmission or the like is input from the smartphone, the mobile phone, or the like, the controller 236 of the mashup agent 23 can synthesize a speech from the text-format communication data and supply the speech to the individual agent, or transmit the text-format communication data to the mashup service 15 on the cloud 10 over the network.

Note that the present technology may take the following configurations.

(1) An information processing apparatus, including

a controller configured to perform control to

detect an intent of a user,

operate an agent capable of providing a service corresponding to the detected intent of the user, and
present, to the user, a result provided to the agent from the service.

(2) The information processing apparatus according to (1), in which

the controller operates multiple agents capable of respectively providing multiple services corresponding to the detected intent of the user, and presents, to the user, results respectively provided to the multiple agents from the multiple services.

(3) The information processing apparatus according to (2), in which

the controller presents, to the user, the results respectively provided to the multiple agents from the multiple services together with an evaluation result of the results.

(4) The information processing apparatus according to (1) to (3), further including

a voice input unit that inputs the intent of the user through voice.

(5) The information processing apparatus according to any one of (1) to (4), in which

the controller presents the result of the service to the user through speech, screen display, or both of the speech and the screen display.

(6) The information processing apparatus according to any one of (2) to (5), in which

the controller saves communication between the user and one of the agents as session data in a session data storage unit, and communicates with another one of the agents by using the session data saved in the session data storage unit.

(7) The information processing apparatus according to (6), in which

the controller presents, when receiving a question absent in the session data from the other agent during communication with the other agent, the question to the user and transmits an answer of the user to the other agent.

(8) The information processing apparatus according to any one of (1) to (7), in which

the controller disables, when the user inputs a command speech with trigger for activating the individual agent, a detection of the intent of the user from the command speech.

(9) The information processing apparatus according to any one of (1) to (8), in which

when a function of one of the specific services is being used and when an intent of the user to use a function of another specific service is detected, the function of the other specific service being prevented from being used simultaneously with the function of the one specific service, the controller prevents use of the function of the other specific service based on the intent of the user.

(10) The information processing apparatus according to any one of (1) to (9), in which

when a relationship between a function of the service used for the detected intent of the user and a surrounding situation corresponds to a specific prevention condition, the controller prevents use of the function of the service for the detected intent of the user.

(11) An information processing method, including:

by a controller,

detecting an intent of a user;

operating an agent capable of operating a service corresponding to the detected intent of the user; and

presenting, to the user, a result provided to the agent from the service.

(12) The information processing method according to (11), in which

the controller operates multiple agents capable of respectively providing multiple services corresponding to the detected intent of the user, and presents, to the user, results respectively provided to the multiple agents from the multiple services.

(13) The information processing method according to (12), in which

the controller presents, to the user, the results respectively provided to the multiple agents from the multiple services together with an evaluation result of the results.

(14) The information processing method according to any one of (11) to (13), further including

inputting the intent of the user through voice.

(15) The information processing method according to any one of (11) to (14), in which

the controller presents the result of the service to the user through speech, screen display, or both of the speech and the screen display.

(16) The information processing method according to any one of (12) to (15), in which

the controller saves communication between the user and one of the agents as session data in a session data storage unit, and communicates with another one of the agents by using the session data saved in the session data storage unit.

(17) The information processing method according to (16), in which

the controller presents, when receiving a question absent in the session data from the other agent during communication with the other agent, the question to the user and transmits an answer of the user to the other agent.

(18) The information processing method according to any one of (11) to (17), in which

the controller disables, when the user inputs a command speech with trigger for activating the individual agent, a detection of the intent of the user from the command speech.

(19) The information processing method according to any one of (11) to (18), in which

when a function of one of the specific services is being used and when an intent of the user to use a function of another specific service is detected, the function of the other specific service being prevented from being used simultaneously with the function of the one specific service, the controller prevents use of the function of the other specific service based on the intent of the user.

(20) The information processing method according to any one of (11) to (19), in which

when a relationship between a function of the service used for the detected intent of the user and a surrounding situation corresponds to a specific prevention condition, the controller prevents use of the function of the service for the detected intent of the user.

### REFERENCE SIGNS LIST

16a, 16b service
21, 22 individual agent
23 mashup agent
24 cache
231 voice input unit
232 speech output unit
234 display unit
235 wireless communication unit
236 controller

1. An information processing apparatus, comprising
a controller configured to perform control to
detect an intent of a user,
operate an agent capable of providing a service corresponding to the detected intent of the user, and
present, to the user, a result provided to the agent from the service.

2. The information processing apparatus according to claim 1, wherein
the controller operates multiple agents capable of respectively providing multiple services corresponding to the detected intent of the user, and presents, to the user, results respectively provided to the multiple agents from the multiple services.

3. The information processing apparatus according to claim 2, wherein
the controller presents, to the user, the results respectively provided to the multiple agents from the multiple services together with an evaluation result of the results.

4. The information processing apparatus according to claim 3, further comprising
a voice input unit that inputs the intent of the user through voice.

5. The information processing apparatus according to claim 4, wherein
the controller presents the result of the service to the user through speech, screen display, or both of the speech and the screen display.

6. The information processing apparatus according to claim 2, wherein
the controller saves communication between the user and one of the agents as session data in a session data storage unit, and communicates with another one of the agents by using the session data saved in the session data storage unit.

7. The information processing apparatus according to claim 6, wherein
the controller presents, when receiving a question absent in the session data from the other agent during communication with the other agent, the question to the user and transmits an answer of the user to the other agent.

8. The information processing apparatus according to claim 1, wherein
the controller disables, when the user inputs a command speech with trigger for activating the individual agent, a detection of the intent of the user from the command speech.

9. The information processing apparatus according to claim 1, wherein
when a function of one of the specific services is being used and when an intent of the user to use a function of another specific service is detected, the function of the other specific service being prevented from being used simultaneously with the function of the one specific service, the controller prevents use of the function of the other specific service based on the intent of the user.

10. The information processing apparatus according to claim 1, wherein
when a relationship between a function of the service used for the detected intent of the user and a surrounding situation corresponds to a specific prevention condition, the controller prevents use of the function of the service for the detected intent of the user.

11. An information processing method, comprising:
by a controller,
detecting an intent of a user;
operating an agent capable of providing a service corresponding to the detected intent of the user; and
presenting, to the user, a result provided to the agent from the service.

12. The information processing method according to claim 11, wherein
the controller operates multiple agents capable of respectively providing multiple services corresponding to the detected intent of the user, and presents, to the user, results respectively provided to the multiple agents from the multiple services.

13. The information processing method according to claim 12, wherein
the controller presents, to the user, the results respectively provided to the multiple agents from the multiple services together with an evaluation result of the results.

14. The information processing method according to claim 13, further comprising
inputting the intent of the user through voice.

15. The information processing method according to claim 14, wherein
the controller presents the result of the service to the user through speech, screen display, or both of the speech and the screen display.

16. The information processing method according to claim 12, wherein
the controller saves communication between the user and one of the agents as session data in a session data storage unit, and communicates with another one of the agents by using the session data saved in the session data storage unit.

17. The information processing method according to claim 16, wherein
the controller presents, when receiving a question absent in the session data from the other agent during communication with the other agent, the question to the user and transmits an answer of the user to the other agent.

18. The information processing method according to claim 11, wherein
the controller disables, when the user inputs a command speech with trigger for activating the individual agent, a detection of the intent of the user from the command speech.

19. The information processing method according to claim 11, wherein
when a function of one of the specific services is being used and when an intent of the user to use a function of another specific service is detected, the function of the other specific service being prevented from being used simultaneously with the function of the one specific service, the controller prevents use of the function of the other specific service based on the intent of the user.

20. The information processing method according to claim 11, wherein
when a relationship between a function of the service used for the detected intent of the user and a surrounding situation corresponds to a specific prevention condition, the controller prevents use of the function of the service for the detected intent of the user.
